(19) United States
(12) Patent Application Publication
(10) Pub. No.: US 2025/0115774 A1
(43) Pub. Date: Apr. 10, 2025

(54) HIGH PERFORMANCE THERMOSET RESINS FOR 3D PRINTING

(71) Applicant: NOGA 3D INNOVATIONS LTD, Rosh Haayin (IL)

(72) Inventors: Yuval VIDAVSKY, Rosh Haayin (IL); Nurit ATAR, Rosh Haayin (IL); Eitan GROSSMAN, Rosh Haayin (IL)

(73) Assignee: NOGA 3D INNOVATIONS LTD, Rosh Haayin (IL)

(21) Appl. No.: 18/729,422

(22) PCT Filed: Jan. 18, 2023
(86) PCT No.: PCT/IL2023/050053

§ 371 Date: Jul. 16, 2024

Related U.S. Application Data
(60) Provisional application No. 63/266,890, filed on Jan. 18, 2022.

(51) Int. Cl. C09D 11/106; B33Y 70/00; C09D 11/101

(52) U.S. Cl. CPC C09D 11/106; B33Y 70/00; C09D 11/101

(57) ABSTRACT

The technology concerns ink formulations for additive manufacturing including a combination of imide-extended bismaleimides (IE-BMI) and cyanate esters.

### FIELD OF THE INVENTION

The present invention relates generally to ink compositions for use in additive manufacturing (AM), and more particularly to development of high-performance-thermosets based ink for three-dimensional (3D) printing by digital light processing (DLP) and stereolithography (SLA) technologies.

### BACKGROUND OF THE INVENTION

In digital light processing/stereolithography (DLP/SLA) 3D printing technologies, construction of a three-dimensional object is performed in a stepwise or layer-by-layer manner. In particular, layer formation is performed through solidification of a photocurable resin mediated by visible or UV light radiation. Two printing approaches are known: one in which new layers are formed at the top surface of a growing object and the other in which new layers are formed at a bottom surface of the growing object [1]. Other approaches are disclosed in U.S. Pat. No. 7,438,846 [2], U.S. Pat. No. 7,892,474 [3], US Patent Application No. 2013/0292862 [4], US Patent Application No. 2013/0295212 [5]; and others. Materials for use in such methodologies are generally limited, and there is a need for new resins with high performance properties for different product families if three-dimensional fabrication is to achieve its full potential.

High performance thermosets polymers are materials with superior thermal stability and mechanical properties that make them valuable in the manufacture of structural products. Examples of high-performance thermosets polymers include polyimide, cyanate ester, epoxy, bismaleimide, phenolic resins and polybenzoxazines.

### PUBLICATIONS

[1]U.S. Pat. No. 5,236,637;
[2]U.S. Pat. No. 7,438,846;
[3]U.S. Pat. No. 7,892,474;
[4] US Patent Application No. 2013/0292862; and
[5] US Patent Application No. 2013/0295212.

### SUMMARY OF THE INVENTION

The present invention relates to formulations for 3D printing by photopolymerization of high-performance thermoset materials that are based on Bismaleimides-Triazine (BT) inks. In most general terms, ink formulations of the invention comprise at least one imide-extended-bismaleimides (IE-BMI)-based material, acting as a chemical precursor, and at least one cyanate ester as a reactive diluent.

In a first aspect of the invention, there is provided an ink formulation for additive manufacturing, the formulation comprising at least one imide-extended-bismaleimides (IE-BMI), at least one cyanate ester and optionally at least one additive.

The invention further provides use of IE-BMI in a formulation for additive manufacturing, the formulation optionally further comprising cyanate ester, a liquid carrier and at least one additive.

Further provided is a method for 3D printing comprising using an ink formulation comprising IE-BMI and/or E-BMI and optionally further comprising cyanate ester, a liquid carrier and at least one additive, wherein the 3D printing comprises additive manufacturing, as further defined herein.

In some embodiments of aspects of the invention, a formulation according to the invention or used according to methods of the invention comprises at least one IE-BMI and/or at least one E-BMI, at least one cyanate ester and optionally at least one additive.

In some further embodiments, the formulation further comprises a carrier. In some embodiments, a carrier is not used, rather the cyanate ester which is present is used to dissolve the IE-BMI.

Additives that may be present, may be selected amongst reactive and non-reactive materials. Non-limiting examples of reactive materials include photo reactive diluents such as acrylates, methacrylates, thiols, vinyl ethers, and epoxy containing curable materials; aromatic bismaleimides; short aliphatic bismaleimides; radical polymerization initiators; and/or photo-initiators such as benzophenones, aromatic α-hydroxy ketones, benzylketals, aromatic α-aminoketones, phenylglyoxalic acid esters, mono-acylphosphinoxides, bis-acylphosphinoxides, tris-acylphosphinoxides and/or oximesters derived from aromatic ketones. Non-limiting examples of non-reactive materials (i.e., non-curable materials) include surface active agents i.e., surfactants; inhibitors; antioxidants; pigments; dyes; dispersants; and/or reinforcement fillers including micro and nanoparticles composed of silica, alumina, carbon black, carbon nanotubes, boron nitride or chopped fibers.

Formulations of the invention may further comprise carbonaceous materials and other functional materials such as graphite, short carbon fibers, carbon nanotubes (CNT), fused silica particles, graphene oxide, and 2D materials such as boron nitride (BN), MoS₂ and WS₂.

Formulations of the invention may further comprise an inorganic precursor or a sol gel precursor that is soluble in the formulation. This material is not an inorganic particulate matter. In some embodiments, the inorganic precursor or sol gel precursor is added in order to form metal oxide particles which serve as fillers, or to bind directly to the resin and act as a crosslinker. An in situ sol gel process can take place in two ways:
a. A one-step sol gel—in case liquid precursors and additives are mixed with the epoxide components in one pot.
b. A two-step preparation of a homogenous sol solution from the liquid precursor, followed by addition to the epoxide components.

Either way, an intermediate reactive M-OH moiety may be formed (wherein M is a metal atom). The sol gel precursors may include di-, tri- and tetra-alkoxysilane (e.g. tetraethoxysilane (TEOS), (3-isocyanatopropyl)trimethoxysilane); bisaminosilane; acryloxymethyltrimethoxysilane; methyltriethoxysilane; dimethyldimethoxysilane; phenyltrimethoxysilane; acryloxypropyltrimethoxysilane (APTMS); (3-glycidoxypropyl) trimethylsilane; silanols such as silanediols, silanetriols, and trisilanolPhenyl (POSS); aluminum lactate; aluminum alokoxides such as aluminum isopropoxide; aluminum chloride; tris (ethyl acetoacetate) aluminum; zirconium alkoxide such as zirconium propoxide; zirconium nitrate; titanium alkoxide such as titanium isopropoxide, titanium n-butoxide and titanium ethoxide; niobium ethoxide. The sol-gel precursor may be present in an amount of <40% by weight.

In some embodiments, formulations of the invention may comprise at least one additive, typically a reactive additive, such as polyamines, e.g., oligomeric polyamines capable of undergoing Michael addition reaction with maleimide functionalities; photo reactive diluents; aromatic bismaleimides; radical polymerization initiators; photo-initiators; surfactants; stabilizers; carriers or solvents; and reinforcement materials such as nanoparticles or chopped fibers.

In some embodiments, formulations of the invention may further comprise at least one metal catalyst such as zinc(II) acetylacetonate hydrate.

In some embodiments, the formulation may further comprise melamine, melamine derivatives, cyanate esters, phenols and aromatic amines. In some embodiments, the melamine derivative is an alkylated melamine having an alkyl moiety of between 1 and 10 carbons (C1-C10 alkyl), such as methylated or butylated melamine.

Extended bismaleimides are a class of bismaleimides (BMIs) that are used for preparing thermoset materials. They are structured of imide moieties in low molecular weight pre-polymers that have reactive terminal or pendant groups, capable of undergoing homopolymerization and/or copolymerization by UV, thermal or catalytic means resulting in a formation of cross-linked solid products. These materials are characterized by relative ease of processing and an ability to tailor specific rheological properties by controlling their molecular weight. Additionally, crosslinked thermoset BMIs have excellent retention of physical properties at high temperatures, in wet environments and in the presence of solvents and lubricating fluids.

Imide-Extended-Bismaleimides (IE-BMI) are materials having a bismaleimide structure, wherein the two maleimides are separated by a variant R that is an extended structure moiety having end maleimide functionalities. A general extended bismaleimide is depicted by the structure

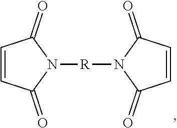

wherein R may be any carbon chain or carbon-based functionality separating the two maleimide groups. The R functionality may be any such moiety having end imide (e.g., cyclic imide) functionalities

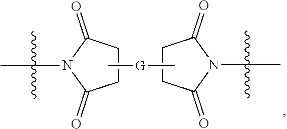

wherein variant G is any carbon-based moiety and wherein each of the dashed lines designated connectivity to the nitrogen atoms of the extended bismaleimide shown above. Thus, an imide-extended bismaleimide may be of the general structure (I):

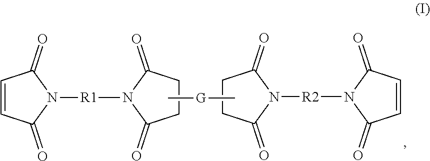

wherein each of R1, R2 and G, independently of the other, is as defined herein, and wherein any of the imide moieties associated to variant G may be selected amongst substituted cyclic imides, fused cyclic imides, aryl-substituted or aryl-fused cyclic imides and others, as further disclosed herein.

The IE-BMIs used according to the invention are amorphous, low molecular weight bismaleimide oligomers that exhibit good adhesion to a variety of substrates. These materials can be homo-cured as depicted in FIG. 1A, or specifically in FIG. 1B, under UV or free radical conditions to form tough, hydrophobic, cross-linked polyimides.

The amorphous nature of these imide-extended BMIs allows the formation of room-temperature-stable solutions in a variety of reactive diluents. IE-BMIs are used in aerospace, microelectronics, automotive and other industries. These materials have exceptional thermal stability, excellent low pH hydrolytic resistance, low dielectric constant, radiation resistance, inertness to solvents, dielectric loss and moisture uptake, high ductility, highly hydrophobic and relatively low modulus and strength. IE-BMIs are photo and thermally curable with and without the addition of photo or thermal initiators which makes them suitable for photo induced 3D printing processes. However, IE-BMIs have relatively high viscosities which makes them less suitable as ink components in 3D printing processes.

IE-BMIs used according to the invention are of the general structure (I):

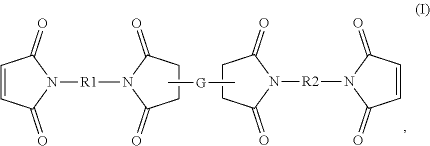

wherein each of R1 and R2, independently, is selected from carbon-based groups having between 1 and 50 carbon atoms and which may be selected from aliphatic groups, aromatic groups, heteroaromatic groups, carbocyclic groups, saturated groups, and unsaturated groups;

G is a carbon-based group having between 1 and 50 carbon atoms and which may be selected from an aliphatic group, an aromatic group, a heteroaromatic group, a carbocyclic group, a saturated group, and an unsaturated group; and wherein each of the cyclic imide is optionally a fused ring or a substituted ring system.

In some embodiments, each of R1, R2 and G, independently of the other, is an alkylene group having between 1 and 50 carbon atoms, an alkenylene or alkynylene group having between 2 and 50 carbon atoms, a carbocyclyl group having between 4 and 10 carbon atoms, an aromatic or a heteroaromatic group having between 6 and 10 carbon atoms, and optionally one or more heteroatoms, wherein each of R1 and R2 and G may be optionally substituted.

In some embodiments, each of R1, R2 and G, independently of the other, is an alkylene group having between 1 and 50 carbon atoms. In some embodiments, the alkylene having between 1 and 45, 1 and 40, 1 and 45, 1 and 35, 1 and 30, 1 and 25, 1 and 20, 1 and 15, 1 and 10, 1 and 9, 1 and 8, 1 and 7, 1 and 6, 1 and 5, 1 and 4, 10 and 50, 10 and 45, 10 and 40, 10 and 35, 10 and 30, 10 and 25, 10 and 20, 5 and 45, 5 and 35, 5 and 25, 5 and 15, or any number of methylene groups between 1 and 50.

In some embodiments, each of R1, R2 and G, independently of the other, is an alkenylene (having one or more double bonds) or alkynylene (having one or more triple bonds) group having between 2 and 50 carbon atoms. In some embodiments, the alkenylene or alkynylene having between 2 and 45, 2 and 40, 2 and 45, 2 and 35, 2 and 30, 2 and 25, 2 and 20, 2 and 15, 2 and 10, 2 and 9, 2 and 8, 2 and 7, 2 and 6, 2 and 5, 2 and 4, 10 and 50, 10 and 45, 10 and 40, 10 and 35, 10 and 30, 10 and 25, 10 and 20, 5 and 45, 5 and 35, 5 and 25, 5 and 15, or any number of methylene groups between 2 and 50.

In some embodiments, each of R1, R2 and G, independently of the other, is a carbocyclyl group having between 4 and 10 carbon atoms. In some embodiments, the carbocyclic group is a 4-membered ring, or a 5-, 6-, 7-, or an 8-membered ring or a bicyclic ring system which may be fused or not fused, and which optionally may be substituted as detailed below.

In some embodiments, each of R1, R2 and G, independently of the other, is an aromatic or a heteroaromatic group having between 6 and 10 carbon atoms, and in the case of a heteroaromatic group, may contain one or more heteroatoms selected from N, O and S.

As used herein, the term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The “alkyl” or “alkylene” refers to a radical of a straight-chain or branched saturated hydrocarbon group having from 1 to 100 carbon atoms. In some embodiments, an alkyl/alkylene group has 1 to 20 carbon atoms. In some embodiments, an alkyl/alkylene group has 1 to 50 carbon atoms. Examples of alkyl groups include methyl, ethyl, propyl (e.g., n-propyl, isopropyl), butyl (e.g., n-butyl, tert-butyl, sec-butyl, isobutyl), pentyl (e.g., n-pentyl, 3-pentanyl, amyl, neopentyl, 3-methyl-2-butanyl, tert-amyl), hexyl (e.g., n-hexyl), and others. Any of the alkyl/alkylene groups may be substituted as disclosed herein.

The “heteroalkyl/heteroalkylene” is an alkyl or an alkylene group, which further includes at least one heteroatom (e.g., 1, 2, 3, or 4 heteroatoms) selected from oxygen, nitrogen, or sulfur, which may be substituted on the carbon chain, may be a part of a substituent or may be an interrupting atom provided along a carbon chain.

The “alkenyl/alkenylene” refers to a radical of a straight-chain or branched hydrocarbon group having from 2 to 100 carbon atoms and one or more carbon-carbon double bonds (e.g., 1, 2, 3, or 4 double bonds), which may be in the (E)- or (Z)-configuration.

The “alkynyl/alkynylene” refers to a radical of a straight-chain or branched hydrocarbon group having from 2 to 100 carbon atoms and one or more carbon-carbon triple bonds (e.g., 1, 2, 3, or 4 triple bonds).

The “carbocyclyl” or “carbocyclic” refers to a radical of a non-aromatic cyclic hydrocarbon group having from 3 to 100 ring carbon atoms and no heteroatoms in the ring structure. Exemplary carbocyclyl groups include cyclopropyl, cyclopropenyl, cyclobutyl, cyclobutenyl, cyclopentyl, cyclopentenyl, cyclohexyl, cyclohexenyl, cyclohexadienyl, cycloheptyl, cyclooctyl, cyclooctenyl, bicyclo[2.2.1]heptanyl, bicyclo[2.2.2]octanyl, cyclodecenyl, octahydro-1H-indenyl, and others. The carbocyclic system may be a single ring structure or a multiring, e.g., fused, structure. Similarly, the carbocyclic system may be monocyclic or polycyclic containing a fused, bridged or spiro ring system.

The “heterocyclyl” or “heterocyclic” is a non-aromatic ring system of 3 to 100 carbon atoms, which comprises one or more heteroatoms independently selected from nitrogen, oxygen, and sulfur. Exemples of heterocyclic systems include azirdinyl, oxiranyl, thiiranyl, azetidinyl, oxetanyl, thietanyl, tetrahydrofuranyl, dihydrofuranyl, tetrahydrothiophenyl, dihydrothiophenyl, pyrrolidinyl, dihydropyrrolyl, oxadiazolinyl, thiadiazolinyl, and others.

Unlike the heterocyclic systems, the “aryl” system refers to a radical of a monocyclic or polycyclic (e.g., bicyclic or tricyclic) aromatic ring system having 6-14 ring carbon atoms and no heteroatoms.

The “heteroaryl” refers to a radical of a 5 to 100 carbon atoms, forming a monocyclic or polycyclic (e.g., bicyclic, tricyclic) aromatic ring system, having ring carbon atoms and 1 to 4 ring heteroatoms elected from nitrogen, oxygen, and sulfur.

As used herein, the “unsaturated” group comprises a double or triple bond and the “saturated” group does not contain a double or triple bond, e.g., the moiety only contains single bonds.

Each of the groups defining variant R, namely each of the carbon-based groups having between 1 and several hundred or more carbon atoms and which may be selected from aliphatic groups, aromatic groups, heteroaromatic groups, carbocyclic groups, saturated groups, unsaturated groups, etc, may be independently substituted with one or more groups selected from halogens, —CN, —NO₂, —N₃, —SO₂H, —SO₃H, —OH, —OX, —ON(X)₂, —N(X)₂, —N(OX)X′, —SH, —SX, —SSX, —C(═O)X, —CO₂H, —CHO, —CO₂X, —OC(═O)X, —OCO₂X, —C(═O)N(X)₂, —SO₂X, —SO₂OX, —OSO₂X, —S(═O)X, —OS(═O)X, —Si(X)₃, —OSi(X)₃—C(═O)SX, —C(═S)SX, —SC(═S)SX, —SC(═O)SX, C1-C20 alkyl, C1-C20 perhaloalkyl, C1-C20 alkenyl, C1-C20 alkynyl, heteroC1-C20 alkyl, heteroC1-C20 alkenyl, heteroC1-C20 alkynyl, C3-C10 carbocyclyl, heterocyclyl, aryl, and heteroaryl, wherein each instance of X or X′ is an independent group that is independently selected from hydrogen, alkyl, alkenyl, alkynyl or aryl, as defined.

In some embodiments, each of the cyclic imide groups may be selected amongst fused cyclic imides, aryl-substituted and aryl-fused cyclic imides.

In some embodiments, the TE-BMT is a compound of formula (II):

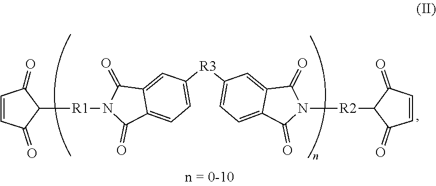

wherein each of R1 and R2 is as defined herein, and wherein R3 is selected from aliphatic groups, aromatic groups, heteroaromatic groups, carbocyclic groups, saturated groups, and unsaturated groups, each as defied, and wherein n is an integer between 0 (forming an E-BMI) and 10 (forming IE-BMI).

In some embodiments, n is different from zero. In some embodiments, n is 1, 2, 3, 4, 5, 6, 7, 8, 9 or 10.

In the compound of formula (II), each of R1, R2 and R3, independently of the other, represents a saturated, unsaturated, aromatic or mixed aliphatic and aromatic group; n is an integer between 0 and 10.

In some embodiments, each of R1, R2, and R3 is different.

In some embodiments, each of R1, R2, R3 is same.

In some embodiments, each of R1, R2 and R3, independently of the other, is selected from saturated, unsaturated, aromatic or mixed aliphatic and aromatic groups.

In some embodiments, each of R1, R2, and R3 is selected from alkyl or alkylene, alkenyl or alkenylene, alkynyl or alkynylene, aryl or arylene, heteroaryl or heteroarylene, and aralkyl or aralkylene.

In some embodiments, R1 is selected from —CH₂—, —O—, —SiR₂—, C═O, bisphenol and others.

In some embodiments, R2 is selected from —CH₂—, —O—, —SiR₂—, C═O, bisphenol and others.

In some embodiments, R3 is selected from —CH₂—, —O—, —SiR₂—, C═O, bisphenol and others.

In some embodiments, each of R1, R2 and R3, independently of the other, is a long chain linker moiety comprising between 20 and 50 carbon atoms, between 25 and 45 carbon atoms, between 30 and 40 carbon atoms.

In some embodiments, each of R1, R2 and R3, independently of the other, comprises between 30 and 40 carbon atoms, or between 35 and 40 carbon atoms or 36 carbon atoms.

In some embodiments, each of R1, R2 and R3, independently of the other, is a C₃₆H₇₀ alkylene group comprising all methylene groups.

In some embodiments, each of R1, R2 and R3, independently of the other, comprises one or more double bonds. In some embodiments, each of R1, R2 and R3, independently of the other, comprises one or more carbocyclyl group.

The reactive extended-BMI can be a liquid or solid or semi solid resin with an average molecular weight up to 10,000 Daltons, e.g., from 500 to 3,000 Daltons.

The reactive IE-BMI can be similarly a liquid or a solid or a semi-solid with an average molecular weight of between 500 and 5000 Dalton.

In some embodiments, the IE-BMI according to the invention is selected from structures (III), (IV) and (V):

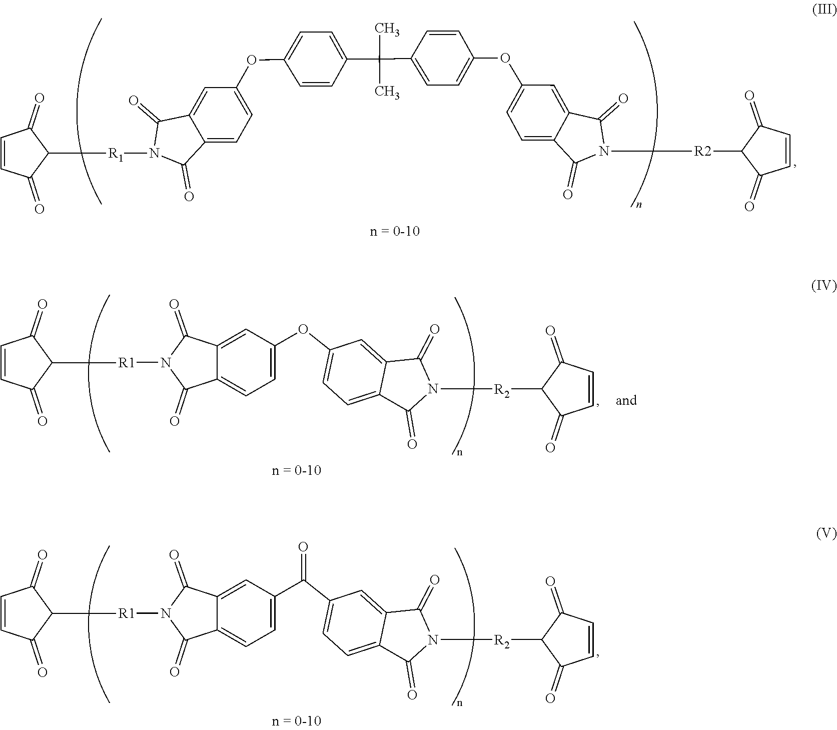

wherein in each of the aforementioned materials of structures (III) to (V), each of R1 and R2, independently, is as defined herein. Each n is between 1 and 10.

In some embodiments, a compound used in formulations of the invention is an E-BMI, such as:

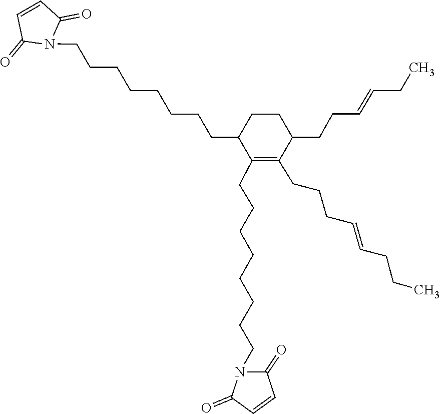 [SMILES: CC/C=C/CCC1CCC(CCCCCCCCN2C(=O)C=CC2=O)C(CCCCCCCCN2C(=O)C=CC2=O)=C1CCC/C=C/CCC]

In some embodiments, in each of structures (III), (IV) and (V), each of R1 and R2 is C₃₆H₇₀ alkylene group.

Non-limiting examples of E-BMI and IE-BMI according to the invention include:

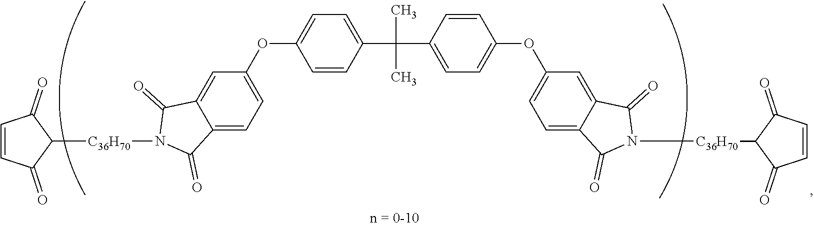

being an example of an IE-BMI;

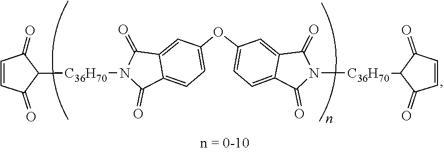

being an example of an IE-BMI;

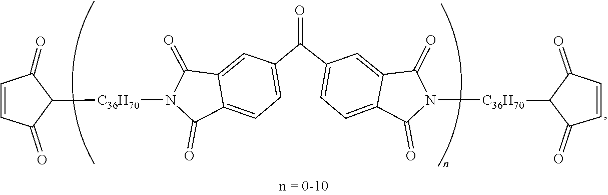

being an example of an TE-BMI; and

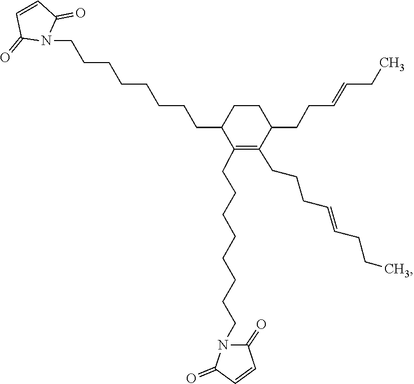 [SMILES: CC/C=C/CCC1CCC(CCCCCCCCN2C(=O)C=CC2=O)C(CCCCCCCCN2C(=O)C=CC2=O)=C1CCC/C=C/CCC]

being an example of an E-BMI.

In a first aspect of the invention, there is provided an ink formulation for additive manufacturing, the formulation comprising at least one imide-extended-bismaleimides (IE-BMI) and/or at least one extended-bismaleimide (E-BMI), at least one cyanate ester and optionally at least one additive.

In some embodiments, the IE-BMI is of the structure (I)

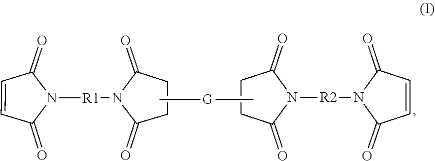

as defined herein.

The double bond of the maleimide end-group is highly electron deficient due to the adjacent electron-withdrawing carbonyl groups. Hence, low molecular weight bismaleimide precursors can undergo homo- and/or copolymerization at the carbon-carbon double bond to provide a crosslinked network. Thus, reactive additives such as oligomeric polyamines that undergo Michael addition reaction with the maleimide functionality may be used to achieve such crosslinked network. The extended-BMI component undergoes quick curing under actinic radiation (0.1-20 seconds per layer), forming a three-dimensional network of a thermosetting polymer material.

Cyanate esters are an important class of high-temperature thermosets which have extremely high glass transition temperatures (up to 400° C.), high tensile strengths, high modulus, and low dielectric constants, dielectric losses and moisture uptakes. These materials are thermally cured at elevated temperatures. The curing mechanism involve three cyano groups of the cyanate ester that are trimerized to generate triazine ring, as shown in FIG. 2.

A general structure of a cyanate ester is provided in FIG. 3A. In the structure shown, n is an integer from 1 to 6 and R is selected from alkyl, cycloalkyl, aryl, heteroaryl, heteroalicyclic and a hydrocarbon (saturated or unsaturated), each as defined herein, optionally interrupted and/or substituted by one or more heteroatoms selected from Si, P, S, O and N.

In some embodiments, in a cyanate ester, R is an aryl, selected from phenyl, naphthyl, anthryl, phenanthryl, or pyrenyl group, each being substituted or unsubstituted.

In some embodiments, in a cyanate ester, R is an aryl selected from phenyl, biphenyl, naphthyl, bis(phenyl)methane, bis(phenyl)ethane, bis(phenyl)propane, bis(phenyl)butane, bis(phenyl)ether, bis(phenyl)thioether, bis(phenyl)sulfone, bis(phenyl) phosphine oxide, bis(phenyl)silane, bis(phenyl)hexafluoropropane, bis(phenyl) trifluoroethane, bis(phenyl)dicyclopentadiene, a phenol formaldehyde resin, each being unsubstituted or substituted by, for example, 1-6 substituents.

In some embodiments, in a cyanate ester, n is 1, 2, 3, 4, 5 or 6. In some embodiments, n is 2, 3, 4 or 5. In some embodiments, n is 2 or 3.

Exemplary cyanate ester compounds include, but are not limited to 1,3-, or 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatoaphthalene; 2,2′ or 4,4′-dicyanatobiphenyl; bis(4-cyanathophenyl)methane; 2,2-bis(4-cyanatophenyl)propane; 2,2-bis(3,5-dichloro-4-cyanatophenyl)propane; 2,2-bis(3-dibromo-4-dicyanatophenyl)propane; bis(4-cyanatophenyl)ether; bis(4-cyanatophenyl) thioether; bis(4-cyanatophenyl)sulfone; tris(4-cyanatophenyl)phosphite; tris(4-cyanatophenyl)phosphate; bis(3-chloro-4-cyanatophenyl)methane: 4-cyanatobiphenyl; 4-cumyl cyanato benzene; 2-tert-butyl-1,4-dicyanatobenzene; 2,4-dimethyl-1,3-dicyanatobenzene; 2,5-di-tert-butyl-1,4-dicyanatobenzene; tetramethyl-1,4-dicyanatobenzene; 4-chloro-1,3-dicyanatobenzene; 3,3′,5,5′-tetramethyl-4,4′dicyanatodiphenyl; bis(3-chloro-4-cyanatophenyl)methane; 1,1,1-tris(4-cyanatophenyl)ethane; 1,1-bis(4-cyanatophenyl)ethane; 2,2-bis(3,5-dichloro-4-cyanatophenyl)propane; 2,2-bis(3,5-dibromo-4-cyanatophenyl)propane; bis(p-cyanophenoxyphenoxy) benzene; and any mixture thereof.

As shown in FIG. 2, curing of the cyanate ester results in trimerization of three CN groups to form a triazine ring. When a monomer contains two cyanate groups, the resulting structure is a 3D polymer network. Thermoset polymer matrix properties can be fine-tuned by the choice of substituents in the bisphenolic compound. Bisphenol A and novolac based cyanate esters are the major products; bisphenol F and bisphenol E are also used. The aromatic ring of the bisphenol can be substituted with an allylic group for improved toughness of the material.

A particular example of cyanate ester thermal curing is depicted in FIG. 3B for bis(4-cyanathophenyl)methane.

Epoxy cationic photo-polymerization is one of the fastest growing areas in the UV-curing industry. It offers the classical UV-curing advantages, as it is solvent-free, energy efficient and takes place at an ambient temperature. Compared to free-radical photo-polymerization, the ring-opening polymerization of epoxy does not suffer from oxygen inhibition, resulting in a very low shrinkage, leading to excellent adhesion and chemical resistance, allowing dark-curing after photo-initiation and thermal post-cure due to very long active centers lifetimes. Cationic systems also benefit from the recent availability of triaryllsulfonium and diaryliodonium salts photo-initiators that are thermally stable at room temperature, and that can be efficiently photo-activated or photosensitized by thioxanthone derivatives.

Moreover, a broad diversity of cationic systems has attracted a lot of interest in combination with hyperbranched polymers and polyols to tailor the material properties or for hybrid organic-inorganic nanocomposites based on fillers or dual-cure sol-gel photo-polymerization processes to improve mechanical properties, thermal stability, scratch resistance and reduce curing shrinkage Bismaleimide Triazine (BT) resin is a heat resistant thermoset resin which contains a mixture of bismaleimide and cyanate ester. BT Resin is one of the most commonly used resin in manufacturing of printed circuit boards (PCBs). It is used in making of substrates used to connect chips used in handsets of PCBs. Three cyano groups of the cyanate ester are homo-cured and trimerized to a triazine ring structure. In addition to the homo-curing of the IE-BMI and the cyanate ester, as mentioned above, the double bond of the maleimide group can copolymerize with the cyano groups to generate heterocyclic 6-membered ring structures (FIGS. 4A and 4B), hence, generating a triple cured system.

Bismaleimide triazine resin is co-reacted with epoxy resins in order to increase the flexibility. BT-Epoxy belongs to the group of thermoset resins used also in printed circuit boards (PCBs). It is a mixture of an epoxy resin, a common raw material for PCBs and BT resins. Blends of triazine resin and epoxy resins will cure by a combination of epoxy insertion into the polycyanurate network and by 5-membered, oxazolidinone ring formation (FIG. 5), hence, generating a quarto cure system. Cured state properties feature T_{g} values higher than aromatic diamine cured epoxies, lower moisture absorption and lower dielectric loss properties.

Bismaleimide triazine (BT) resins can also be mixed with epoxy resins to optimize the end use properties. Epoxy resins, also known as polyepoxides, are a class of reactive prepolymers and polymers which contain epoxide groups. Epoxy resins may be reacted (cross-linked) either with themselves through catalytic homopolymerization, or with a wide range of co-reactants including polyfunctional amines, acids, acid anhydrides, phenols, alcohols and thiols. Reaction of polyepoxides with themselves or with polyfunctional hardeners forms a thermosetting polymer, often with favorable mechanical properties and high thermal and chemical resistance. Cycloaliphatic epoxides contain one or more aliphatic rings in the molecule on which the oxirane ring is contained. Cycloaliphatic epoxides are characterized by their aliphatic structure, high oxirane content and the absence of chlorine, which results in low viscosity and (once cured) good weather resistance, low dielectric constants and high T_{g}. Cycloaliphatic epoxides are usually homopolymerized thermally or UV-initiated in an electrophilic or cationic reaction.

Thus, for tailoring specific mechanical and chemical attributes to a printed pattern or object and to modify the 3D printing technology to achieve such objects, formulations of the invention may comprise in addition to the at least one IE-BMI and the cyanate ester, at least one additional reactive monomer or oligomer selected from polyepoxides or epoxide-rich resins, bismaleimide triazine (BT) resin, extended BMIs, and others.

Formulations of the invention are configured or structured for use in methods of additive manufacturing. As known in the art, “additive manufacturing” refers generally to any process of joining materials to make objects from a 3D model data, usually layer by layer. Depending on whether curing of formulations of the invention may be achievable via thermal curing or photocuring, the methodology used may vary. In some embodiments, additive manufacturing is Vat polymerization, wherein the formulation is cured layer by layer under conditions of light irradiation of a certain wavelength. Two main vat polymerization technologies are digital light processing (DLP) and stereolithography (SLA).

Digital light processing, DLP, is a 3D printing technology which takes a design created in a 3D modeling software and utilizes light and a liquid resin to make solid parts and products. In this process, once a 3D design is sent to the printer, a vat of liquid polymer is exposed to light from a DLP projector displaying the image of the 3D model onto the liquid polymer. The exposed liquid polymer hardens and the process is repeated again layer by layer. The process is repeated until the 3D model is complete and the vat is drained of liquid, revealing the solidified model.

Stereolithography (SLA) and DLP are very similar 3D printing techniques. While both techniques work by selectively exposing a liquid resin to a light source, SLA uses a laser and DLP a projector. While very similar in principle, the two technologies can produce significantly varying outputs.

The invention further provides a process for manufacturing an object, the process comprises printing a formulation according to the invention, wherein the printing is carried out under conditions of DLP or SLA.

Thus, formulations of the invention may be utilized in a variety of additive manufacturing methods as an ink material. In some embodiments, the formulation is used as a resin bath in a Vat-based 3D printing methods.

A method for producing or manufacturing a 3D object may comprise depositing an ink formulation according to the invention onto a substrate and curing said deposited formulation under conditions of thermal curing or photocuring to obtain the 3D object.

In some embodiments, the deposition of the ink formulation is layer by layer, wherein each layer is cured before the next is deposited.

In some embodiments, the ink formulation is provided in a vat bath.

Once formed the object may be further treated under conditions of post treatment, including one or more of:
washing the object with a hydrophobic solvent such as hexyl acetate, pentyl acetate, butyl acetate, propyl acetate, methyl ethyl ketone, tert-butyl methyl ether, cyclohexane, hexane, petroleum ether pentane, and others;
evaporating a solvent that may be contained in or associate with the object;
photo curing the object (UV irradiation) for a period of e.g., 5 to 180 min, or 10 to 60 min;
thermally treating the object to achieve post curing, e.g., under nitrogen atmosphere, at a temperature above room temperature, for example at a temperature between 150° C. to 300° C. for 1 to 12 hours, or stepwise heating to 180° C. for 3 hours, 220° C. for 1 hour and 275° C. for 1 hour.

The method of manufacturing the 3D object is an additive manufacturing process that may involve layer by layer deposition of the ink formulation from a 3D computer-aided design (CAD) model. Materials and processes for special utility products, such as those used in aerospace and automotive applications raise several challenges, including low mass requirement, small production series, challenging material procurement, very high performances, and very high reliability. Additive manufacturing is well-suited for such applications: it is adaptive to very small series, applicable to dimensions range from few micrometers to meters, applicable to a wide variety of materials (polymers, metals, ceramics, composites, tissues and living cells, food for astronauts, etc.), allows for complex geometries that could not be manufactured before, enables reduction of interfaces (e.g., flanges, connectors, cables), allows significant mass reduction, provides performance improvement, short lead time, minimal material waste, and could be used for spacecraft construction and even for in-orbit manufacturing.

The use of objects or generally polymeric materials formed according to the invention or from formulations of the invention in space applications has numerous advantages. Polymers and objects of the invention exhibit properties which allow them to perform in a space environment for a long duration of time, with minimal degradation in spite of the aggressive space conditions which involve exposure to ultrahigh vacuum (UHV), ultraviolet (UV) radiation, ionizing radiation (namely, energetic electrons, protons, and heavy ions), high temperatures, as well as micrometeoroids and debris. Without wishing to be bound by theory, the polymers superiority arises from the polymers' weighted thermal and mechanical properties, such as, strength, modulus, elongation and thermal stability.

Products of processes of the invention or those formed of formulations of the invention may be characterized as polymeric objects, structures or patterns, which may be of any shape and size and which can be implemented in a variety of applications. Generally speaking, products of the invention may be implemented for aerospace aviation, automobile industry, electronic packaging, microelectronic insulation, corrosion resistance, films, medical device, medical implants, as well as in many other fields.

Thus, in another aspect, there is provided a polymeric object, element or device formed of an ink formulation of the invention.

The invention further provides an ink formulation for printing methods as disclosed herein, the ink formulation comprising at least one IE-BMI, (1,1′-bis(4-cyanatophenyl)ethane) as a cyanate ester, zinc(II) acetylacetonate hydrate in isobornyl acrylate, and phenylbis(2,4,6-trimethylbenzoyl) phosphine oxide. In some embodiments, the formulation further comprises at least one E-BMT.

In some embodiments, the IE-BMI and E-BMI are selected from:

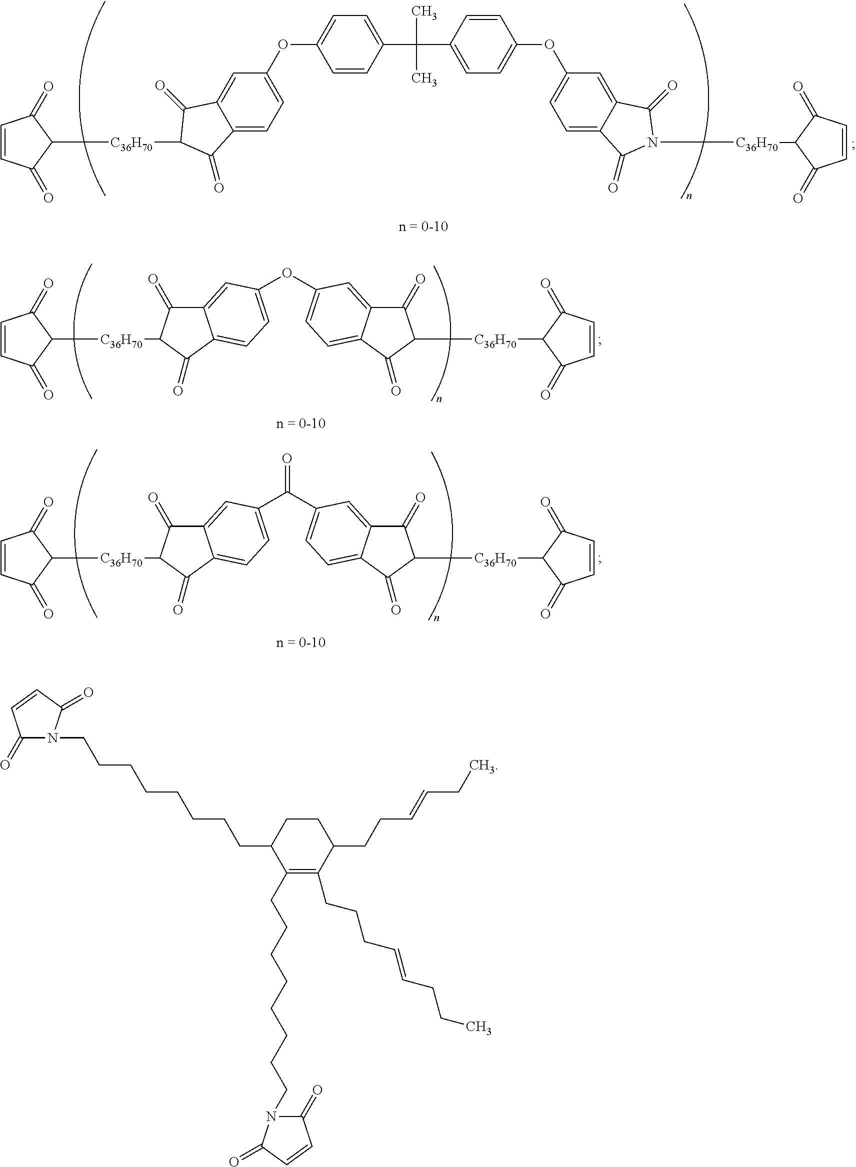

The invention generally further concerns formulations, uses thereof, methods and process and objects:

An ink formulation for additive manufacturing, the formulation comprising at least one imide-extended bismaleimides (IE-BMI), at least one cyanate ester and optionally at least one additive.

Any of the formulations of the invention may further comprise at least one extended bismaleimides (E-BMI).

Any of the formulations of the invention, may be free of a carrier.

Any of the formulations of the invention, may further comprise at least one additive.

Any of the formulations of the invention, the at least one additive may be selected from reactive and non-reactive materials.

Any of the formulations of the invention, the reactive material may be selected from photo reactive diluents; aromatic bismaleimides; short aliphatic bismaleimides; radical polymerization initiators; and photo-initiators.

Any of the formulations of the invention, the non-reactive material may be selected from surfactants; inhibitors; antioxidants; pigments; dyes; dispersants; and reinforcement fillers.

Any of the formulations of the invention, may further comprise at least one carbonaceous material and/or at least one functional material.

Any of the formulations of the invention, at least one carbonaceous material and/or at least one functional material may be selected from graphite, short carbon fibers, carbon nanotubes (CNT), fused silica particles, graphene oxide, and 2D materials.

Any of the formulations of the invention, the 2D materials may be selected from boron nitride (BN), MoS₂ and WS₂.

Any of the formulations of the invention, may further comprise an inorganic precursor or a sol gel precursor soluble in the formulation.

Any of the formulations of the invention, the sol gel precursor may be a di-, tri- or a tetra-alkoxysilane.

Any of the formulations of the invention, the sol gel precursor may be selected from tetraethoxysilane (TEOS), 3-isocyanatopropyl trimethoxysilane; bisaminosilane; acryloxymethyltrimethoxysilane; methyltriethoxysilane; dimethyldimethoxysilane; phenyltrimethoxysilane; acryloxypropyltrimethoxysilane (APTMS); (3-glycidoxypropyl) trimethylsilane; silanediols; silanetriols; trisilanol phenyl (POSS); aluminum lactate; aluminum alokoxides; aluminum isopropoxide; aluminum chloride; tris (ethyl acetoacetate) aluminum; zirconium alkoxide; zirconium propoxide; zirconium nitrate; titanium alkoxide; titanium isopropoxide, titanium n-butoxide; titanium ethoxide; and niobium ethoxide.

Any of the formulations of the invention, the IE-BMI may be of the general structure (I):

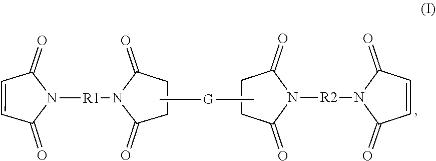

wherein each of R1 and R2, independently, is selected from carbon-based groups having between 1 and 50 carbon atoms;
G is a carbon-based group having between 1 and 50 carbon atoms; and wherein
each of the cyclic imide is optionally a fused ring or a substituted ring system.

Any of the formulations of the invention, each of R1 and R2, independently, may be selected from aliphatic groups, aromatic groups, heteroaromatic groups, carbocyclic groups, saturated groups, and unsaturated groups.

Any of the formulations of the invention, G may be selected from aliphatic groups, aromatic groups, heteroaromatic groups, carbocyclic groups, saturated groups, and unsaturated groups.

Any of the formulations of the invention, each of R1, R2 and G, independently of the other, may be an alkylene group having between 1 and 50 carbon atoms; an alkenylene or alkynylene group having between 2 and 50 carbon atoms; a carbocyclyl group having between 4 and 10 carbon atoms; an aromatic group having between 6 and 10 carbon atoms; and a heteroaromatic group having between 6 and 10 carbon atoms and one or more heteroatoms, wherein each of R1 and R2 and G may be optionally substituted.

Any of the formulations of the invention, each of R1, R2 and G, independently of the other, may be an alkylene group having between 1 and 45, 1 and 40, 1 and 45, 1 and 35, 1 and 30, 1 and 25, 1 and 20, 1 and 15, 1 and 10, 1 and 9, 1 and 8, 1 and 7, 1 and 6, 1 and 5, 1 and 4, 10 and 50, 10 and 45, 10 and 40, 10 and 35, 10 and 30, 10 and 25, 10 and 20, 5 and 45, 5 and 35, 5 and 25, or 5 and 15 carbon atoms, or between 1 and 50 methylene groups.

Any of the formulations of the invention, each of R1, R2 and G, independently of the other, may be an alkenylene or alkynylene group having between 2 and 45, 2 and 40, 2 and 45, 2 and 35, 2 and 30, 2 and 25, 2 and 20, 2 and 15, 2 and 10, 2 and 9, 2 and 8, 2 and 7, 2 and 6, 2 and 5, 2 and 4, 10 and 50, 10 and 45, 10 and 40, 10 and 35, 10 and 30, 10 and 25, 10 and 20, 5 and 45, 5 and 35, 5 and 25, or between 5 and 15 carbon atoms.

Any of the formulations of the invention, each of R1, R2 and G, independently of the other, may be a carbocyclyl group being a 4-membered ring, or a 5-, 6-, 7- or an 8-membered ring or a bicyclic ring system.

Any of the formulations of the invention, each of R1, R2 and G, independently of the other, may be an aromatic or a heteroaromatic group having between 6 and 10 carbon atoms, and in case of a heteroaromatic group, one or more heteroatoms selected from N, O and S.

Any of the formulations of the invention, each of the cyclic imide groups part of the IE-BMI may be selected amongst fused cyclic imides, aryl-substituted and aryl-fused cyclic imides.

Any of the formulations of the invention, the IE-BMI may be a compound of formula (II)

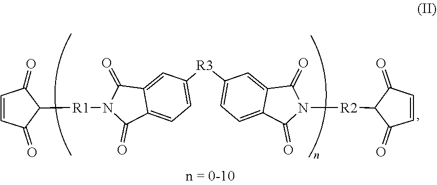

wherein each of R1 and R2 is as defined in claim 12, and wherein R3 is selected from aliphatic groups, aromatic groups, heteroaromatic groups, carbocyclic groups, saturated groups, and unsaturated groups, and wherein n is an integer between 0 and 10.

Any of the formulations of the invention, n may be different from zero.

Any of the formulations of the invention, n may be 1, 2, 3, 4, 5, 6, 7, 8, 9 or 10.

Any of the formulations of the invention, each of R1, R2 and R3, independently of the other, may represent a saturated, unsaturated, aromatic or mixed aliphatic-aromatic group; n is an integer between 0 and 10.

Any of the formulations of the invention, each of R1, R2, and R3 may be different.

Any of the formulations of the invention, each of R1, R2, R3 may be same.

Any of the formulations of the invention, R1 may be selected from —CH₂—, —O—, —SiR₂—, C═O, and bisphenol.

Any of the formulations of the invention, R2 may be selected from —CH₂—, —O—, —SiR₂—, C═O, and bisphenol.

Any of the formulations of the invention, R3 may be selected from —CH₂—, —O—, —SiR₂—, C═O, and bisphenol.

Any of the formulations of the invention, each of R1, R2 and R3, independently of the other, may be a long chain linker moiety comprising between 20 and 50 carbon atoms, between 25 and 45 carbon atoms, or between 30 and 40 carbon atoms.

Any of the formulations of the invention, each of R1, R2 and R3, independently of the other, may comprise between 30 and 40 carbon atoms, or between 35 and 40 carbon atoms or 36 carbon atoms.

Any of the formulations of the invention, each of R1, R2 and R3, independently of the other, may be a C36H70 alkylene group comprising all methylene groups.

Any of the formulations of the invention, the extended-BMI may be a liquid or solid or semi solid resin with an average molecular weight up to 10,000 Daltons.

Any of the formulations of the invention, the IE-BMI may be a liquid or a solid or a semi-solid with an average molecular weight of between 500 and 5000 Dalton.

Any of the formulations of the invention, the IE-BMI may be selected from structures (III), (IV) and (V):

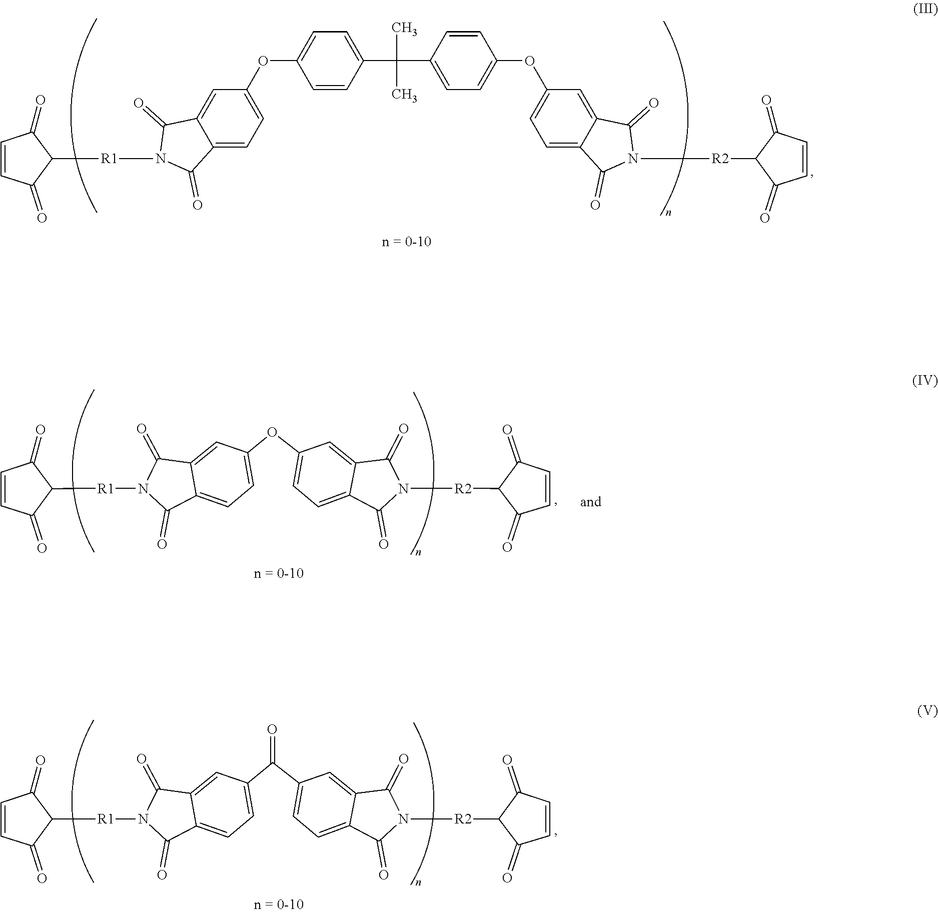

wherein in each of the structures (III) to (V), each of R1 and R2, independently, is as defined in claim 21, and wherein each n is between 1 and 10.

Any of the formulations of the invention, the E-BMT is of a structure:

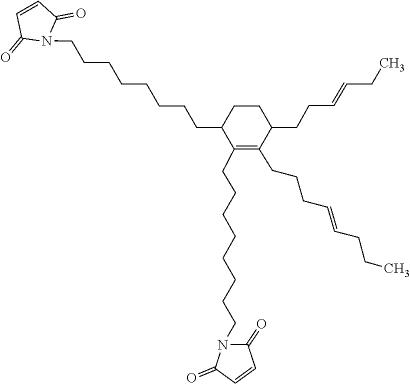 [SMILES: CC/C=C/CCC1CCC(CCCCCCCCN2C(=O)C=CC2=O)C(CCCCCCCCN2C(=O)C=CC2=O)=C1CCC/C=C/CCC]

Any of the formulations of the invention, each of R1 and R2 may be a C36H70 alkylene group.

Any of the formulations of the invention, the IE-BMI may be selected from:

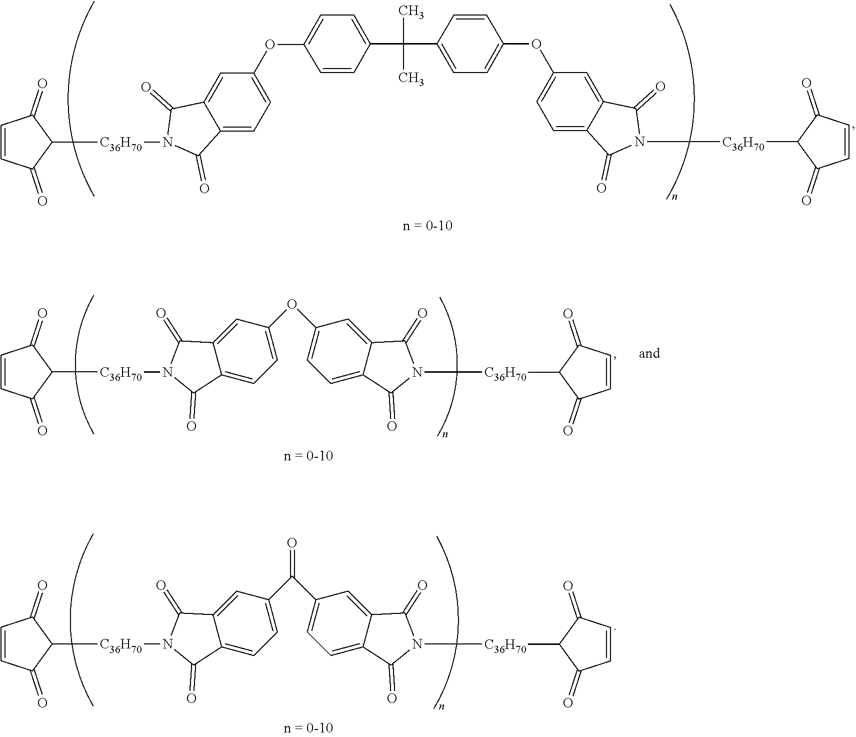

An ink formulation for additive manufacturing, the formulation comprising at least one imide-extended-bismaleimides (IE-BMI) and/or at least one extended-bismaleimide (E-BMI), at least one cyanate ester and at least one additive, wherein the IE-BMI is of the structure (I)

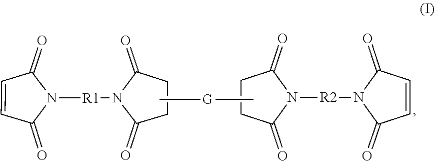

wherein each of R1 and R2, independently, is selected from carbon-based groups having between 1 and 50 carbon atoms;
G is a carbon-based group having between 1 and 50 carbon atoms; and wherein
each of the cyclic imide is optionally a fused ring or a substituted ring system.

Any of the formulations of the invention, the cyanate ester is of structure

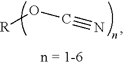

wherein R is selected from alkyl, cycloalkyl, aryl, heteroaryl, heteroalicyclic and a saturated or unsaturated hydrocarbo), optionally interrupted and/or substituted by one or more heteroatoms selected from Si, P, S, O and N, and wherein n is an integer between 1 and 6.

Any of the formulations of the invention, R may be an aryl selected from phenyl, naphthyl, anthryl, phenanthryl, or pyrenyl group, each being substituted or unsubstituted.

Any of the formulations of the invention, R may be an aryl selected from phenyl, biphenyl, naphthyl, bis(phenyl)methane, bis(phenyl)ethane, bis(phenyl)propane, bis(phenyl)butane, bis(phenyl)ether, bis(phenyl)thioether, bis(phenyl)sulfone, bis(phenyl) phosphine oxide, bis(phenyl)silane, bis(phenyl)hexafluoropropane, bis(phenyl) trifluoroethane, bis(phenyl)dicyclopentadiene, a phenol formaldehyde resin, each being unsubstituted or substituted.

Any of the formulations of the invention, n may be different from zero or may be 1, 2, 3, 4, 5 or 6, or n is 2 or 3.

Any of the formulations of the invention, the cyanate ester may be selected from 1,3-, or 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatoaphthalene; 2,2′ or 4,4′-dicyanatobiphenyl; bis(4-cyanathophenyl)methane; 2,2-bis(4-cyanatophenyl)propane; 2,2-bis(3,5-dichloro-4-cyanatophenyl)propane; 2,2-bis(3-dibromo-4-dicyanatophenyl)propane; bis(4-cyanatophenyl)ether; bis(4-cyanatophenyl) thioether; bis(4-cyanatophenyl)sulfone; tris(4-cyanatophenyl)phosphite; tris(4-cyanatophenyl)phosphate; bis(3-chloro-4-cyanatophenyl)methane: 4-cyanatobiphenyl; 4-cumyl cyanato benzene; 2-tert-butyl-1,4-dicyanatobenzene; 2,4-dimethyl-1,3-dicyanatobenzene; 2,5-di-tert-butyl-1,4-dicyanatobenzene; tetramethyl-1,4-dicyanatobenzene; 4-chloro-1,3-dicyanatobenzene; 3,3′,5,5′-tetramethyl-4,4′dicyanatodiphenyl; bis(3-chloro-4-cyanatophenyl)methane; 1,1,1-tris(4-cyanatophenyl)ethane; 1,1-bis(4-cyanatophenyl)ethane; 2,2-bis(3,5-dichloro-4-cyanatophenyl)propane; 2,2-bis(3,5-dibromo-4-cyanatophenyl)propane; bis(p-cyanophenoxyphenoxy) benzene; and any mixture thereof.

Any of the formulations of the invention, may further comprise a bismaleimide triazine (BT) resin.

Any of the formulations of the invention, may further comprising an epoxy resin.

Any of the formulations of the invention, may be for use in a method of additive manufacturing.

Any of the formulations of the invention, the additive manufacturing may be Vat polymerization.

Any of the formulations of the invention, the method may comprise layer by layer deposition of the formulation, wherein each layer is cured under conditions of light irradiation.

Any of the formulations of the invention, may be for use in digital light processing (DLP) or stereolithography (SLA).

A process for manufacturing an object, the process comprises printing a formulation according to any one of claims 1 to 53, wherein the printing is carried out under conditions of digital light processing (DLP) or stereolithography (SLA).

Any of the processes of the invention, the process comprises depositing the formulation onto a substrate and curing said deposited formulation under conditions of thermal curing or photocuring to obtain the 3D object.

Any of the processes of the invention, the deposition of the formulation may be layer by layer, wherein each layer is cured before the next is deposited.

Any of the processes of the invention, the ink formulation may be provided in a vat bath.

An object formed of a formulation according to the invention, wherein the object is a polymeric object, structure or pattern, implemented for use in aerospace aviation, automobile industry, electronic packaging, microelectronic insulation, corrosion resistance, films, medical device, and medical implants.

An object formed of a process according to the invention, wherein the object is a polymeric object, structure or pattern, implemented for use in aerospace aviation, automobile industry, electronic packaging, microelectronic insulation, corrosion resistance, films, medical device, and medical implants.

A formulation for use in additive manufacturing, the formulation comprising at least one cyanate ester, optionally at least one additive, and at least one bismaleimide selected from

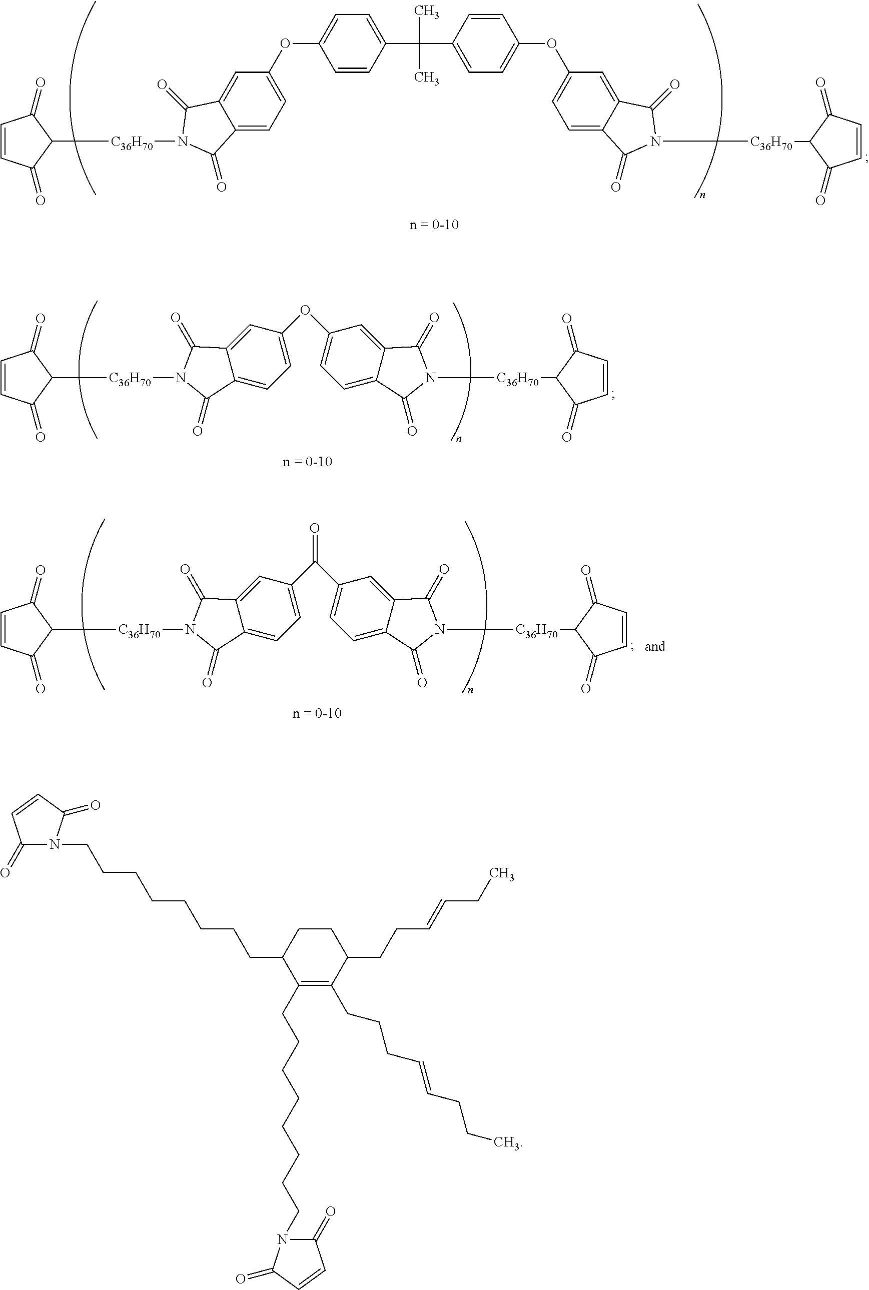

Any of the formulation of the invention, the formulation may be in a form of a resin, which optionally further comprises a photoinitiator and at least one metal catalyst, such as zinc(II) acetylacetonate hydrate.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A depicts a general mechanistic description of homopolymerization of maleimides. Each group R is independently an N-substituting moiety, as disclosed herein.

FIG. 1B provides a depiction of homopolymerization of an IE-BMI of structure (IV), as defined herein.

FIG. 2 provides a mechanistic depiction of homopolymerization of cyanate esters, wherein each group R is independently a substituting moiety, as disclosed herein.

FIG. 3A presents a general structure of cyanate esters FIG. 3B presents a general mechanstic depition of cynate ester homopolymerization.

FIG. 4A shows a depiction of a curing mechanism of maleimide and cyanate ester, wherein each group R is independently an N-substituting moiety or an O-substituting moiety, as disclosed herein.

FIG. 4B shows copolymerization of an IE-BMI of structure (IV) with a cyanate ester.

FIG. 5 depicts curing mechanism of epoxy and cyanate ester, wherein each group R is independently a substituting moiety, as disclosed herein.

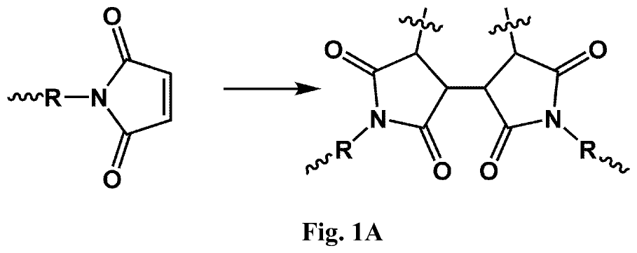

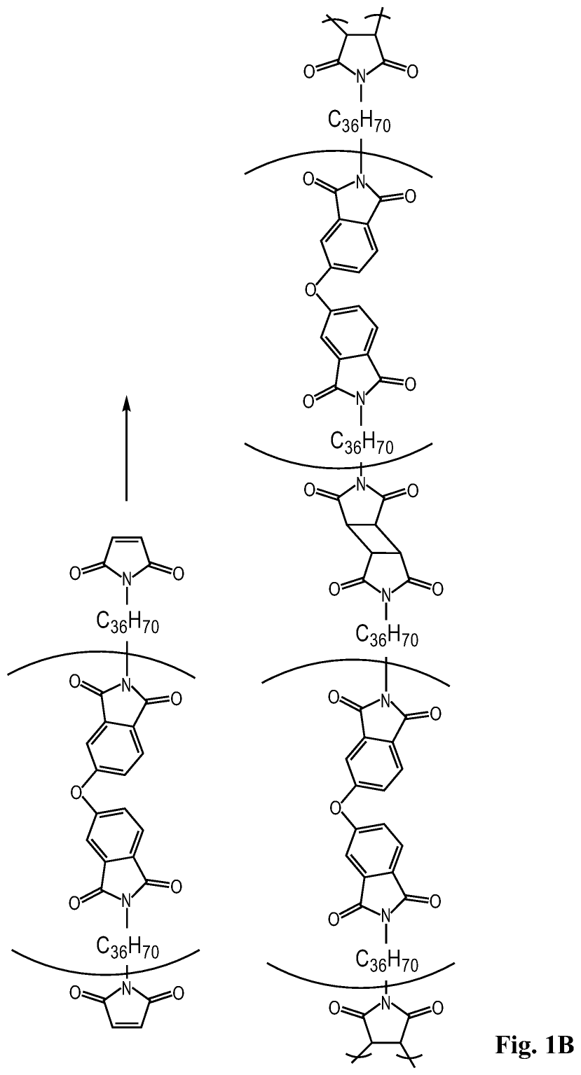

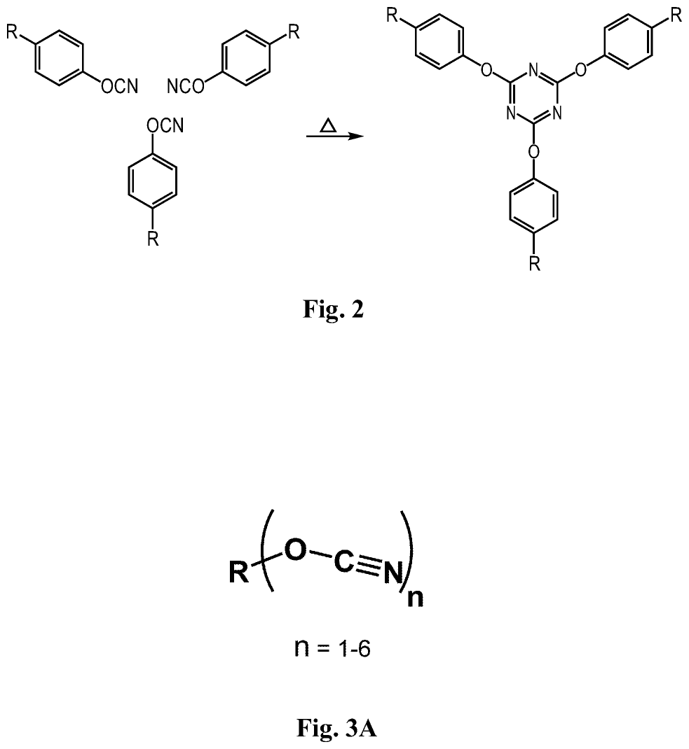

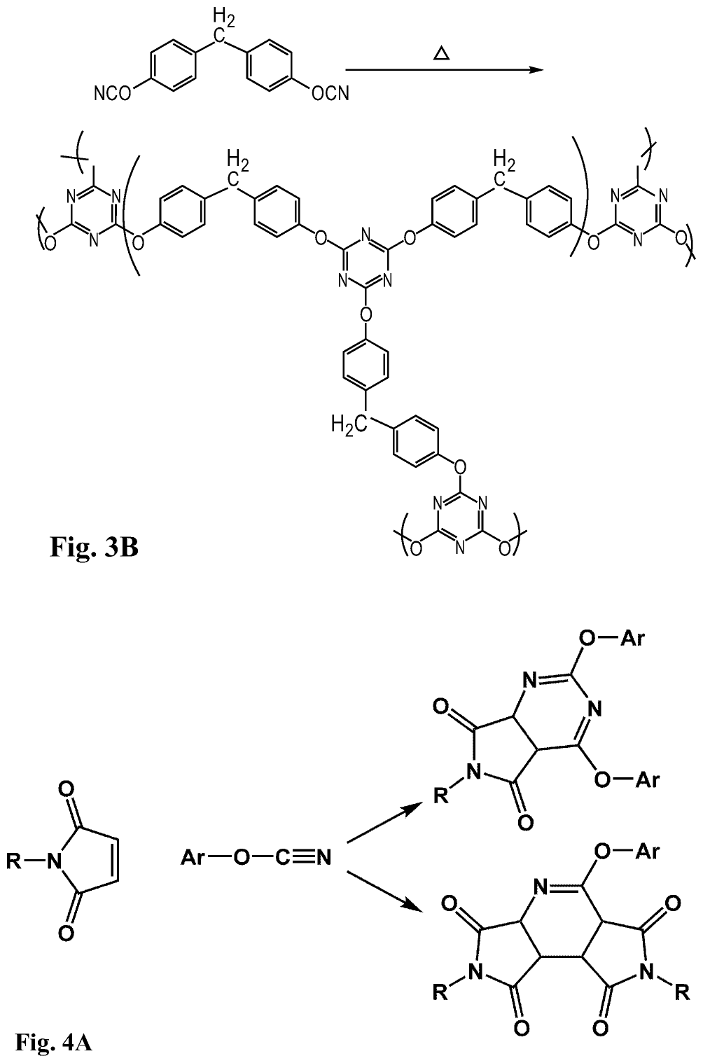

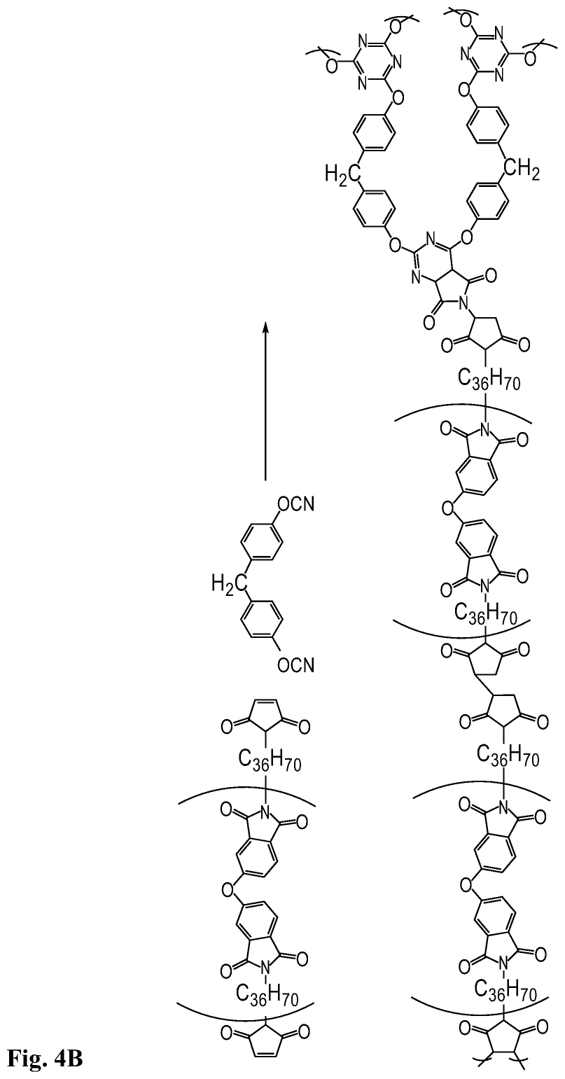

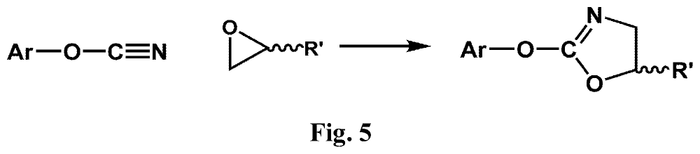

### DETAILED DESCRIPTION OF THE INVENTION

### Examples

### Example 1: BT Based Formulation Triple Cure Resin and Product

BT formulation was prepared by mixing of 20 gr of IE-BMI (BMI-1700), 20 gr of bismaleimide based on a non-hydrogenated dimer diamine backbone (E-BMI, BMI-689), 60 gr of Cyanate Ester (1,1′-bis(4-cyanatophenyl)ethane), 2 gr of a metal catalyst solution that promotes polymerization of a cyanate ester(3000 ppm zinc(II) acetylacetonate hydrate in isobornyl acrylate), and 0.8 gr of photoinitiator (phenylbis(2,4,6-trimethylbenzoyl) phosphine oxide) were mixed with a magnetic stirrer at 60° C. till a complete dissolution was achieved to yield a homogeneous resin.

This resin was formed into a three-dimensional intermediate using ASIGA DLP printer, using a 385 nm LED projector with a light intensity of 31 mW/cm². The formed material was washed and cured for 30 min under UV irradiation. Further post curing was done for 180 minutes at 180° C., 60 minutes at 250° C., and 1 hour at 275° C. to yield the desired product. The thermo mechanical properties of the products were evaluated and are given in Table 1 below.

### Example 2: BT-Epoxy Based Formulation Quatro Cure Resin and Product

BT-Epoxy formulation was prepared by mixing of 16 gr of IE-BMI (BMI-1700), 16 gr E-BMI (BMI-689), 60 gr of Cyanate Ester (1,1′-bis(4-cyanatophenyl)ethane), 2 gr of a metal catalyst solution that promotes polymerization of a cyanate ester (3000 ppm zinc(II) acetylacetonate hydrate in isobornyl acrylate), 0.8 gr of radical photoinitiator (phenylbis(2,4,6-trimethylbenzoyl) phosphine oxide), 8 gr of epoxymethacrylate hybrid crosslinker reactive diluent (3,4-epoxycyclohexyl methyl methacrylate) and 0.16 gr of cationic photoinitiator (triarylsulfonium hexafluoroantimonate salts mixture in propylene carbonate) were mixed with a magnetic stirrer at 60° C. till a complete dissolution was achieved to yield a homogeneous resin.

This resin was formed into a three-dimensional intermediate using ASIGA DLP printer, using a 385 nm LED projector with a light intensity of 31 mW/cm². The formed material was washed and cured for 30 min under UV irradiation. Further post curing was done for 180 minutes at 180° C., 60 minutes at 250° C., and 1 hour at 275° C. to yield the desired product. The thermo mechanical properties of the products were evaluated and are given in Table 1 below.

### Example 3: BT-Epoxy Based Formulation Quatro Cure Resin and Product

BT-Epoxy formulation was prepared by mixing of 13.5 gr of IE-BMI (BMI-1700), 13.5 gr of E-BMI (BMI-689), 60 gr of Cyanate Ester (1,1′-bis(4-cyanatophenyl)ethane), 2 gr of metal catalyst solution that promotes polymerization of a cyanate ester(3000 ppm zinc(II) acetylacetonate hydrate in isobornyl acrylate), 0.8 gr of radical photoinitiator (phenylbis(2,4,6-trimethylbenzoyl) phosphine oxide), 13.1 gr of epoxymethacrylate hybrid crosslinker reactive diluent (3,4-epoxycyclohexyl methyl methacrylate) and 0.26 gr of cationic photoinitiator (triarylsulfonium hexafluoroantimonate salts mixture in propylene carbonate) were mixed with a magnetic stirrer at 60° C. till a complete dissolution was achieved to yield a homogeneous resin.

This resin was formed into a three-dimensional intermediate using ASIGA DLP printer, using a 385 nm LED projector with a light intensity of 31 mW/cm². The formed material was washed and cured for 30 min under UV irradiation. Further post curing was done for 180 minutes at 180° C., 60 minutes at 250° C., and 1 hour at 275° C. to yield the desired product. The thermo mechanical properties of the products were evaluated and are given in Table 1 below.

### Example 4: BT-Acrylate Based Formulation Quatro Cure Resin and Product

BT-Epoxy formulation was prepared by mixing of 16 gr of IE-BMI (BMI-1700), 16 gr of E-BMI (BMI-689), 60 gr of Cyanate Ester (1,1′-bis(4-cyanatophenyl)ethane), 2 gr of metal catalyst solution that promotes polymerization of a cyanate ester (3000 ppm zinc(II) acetylacetonate hydrate in Isobornyl acrylate), 0.8 gr of radical photoinitiator (phenylbis(2,4,6-trimethylbenzoyl) phosphine oxide), and 8 gr acrylic crosslinker (tricyclodecanedimethanol diacrylate) were mixed with a magnetic stirrer at 60° C. till a complete dissolution was achieved to yield a homogeneous resin.

This resin was formed into a three-dimensional intermediate using ASIGA DLP printer, using a 385 nm LED projector with a light intensity of 31 mW/cm². The formed material was washed and cured for 30 min under UV irradiation. Further post curing was done for 180 minutes at 180° C., 60 minutes at 250° C., and 1 hour at 275° C. to yield the desired product. The thermo mechanical properties of the products were evaluated and are given in Table 1 below.

### Example 5: BT-Acrylate Based Formulation Quatro Cure Resin and Product

BT-Epoxy formulation was prepared by mixing of 13.5 gr of IE-BMI (BMI-1700), 13.5 gr of E-BMI (BMI-689), 60 gr of Cyanate Ester (1,1′-bis(4-cyanatophenyl)ethane), 2 gr of metal catalyst solution that promotes polymerization of a cyanate ester ((3000 ppm zinc(II) acetylacetonate hydrate in isobornyl acrylate), 0.8 gr of radical photoinitiator (phenylbis(2,4,6-trimethylbenzoyl) phosphine oxide) and 13.1 gr of acrylic crosslinker (tricyclodecanedimethanol diacrylate) were mixed with a magnetic stirrer at 60° C. till a complete dissolution was achieved to yield a homogeneous resin.

This resin was formed into a three-dimensional intermediate using ASIGA DLP printer, using a 385 nm LED projector with a light intensity of 31 mW/cm². The formed material was washed and cured for 30 min under UV irradiation. Further post curing was done for 180 minutes at 180° C., 60 minutes at 250° C., and 1 hour at 275° C. to yield the desired product. The thermo mechanical properties of the products were evaluated and are given in Table 1 below.

TABLE 1
Thermomechanical properties of printed materials

| | | | | | | Ultimate | |
|---|---|---|---|---|---|---|---|
| | | Post | | Storage | Felxural | Flexural | |
| Example | | Cure | | Modulus | Modulus, | Strength, | |
| No. | Resin Name | Temp. | Tg, ° C. | @30° C. | MPa | MPa | HDT, ° C. |
| 1 | BT | 250 | 280 | 1650 | 1350 | 59 | 97 |
| | | 275 | 282 | 1400 | 1150 | 62 | 75 |
| 2 | BT—Acrylic | 250 | 270 | 2065 | 2380 | 97 | 130 |
| | Epoxy | 275 | 259 | 2164 | 2100 | 90 | 139 |
| 3 | BT—Acrylic | 250 | 264 | 2300 | 2403 | 106 | 160 |
| | Epoxy | 275 | 237 | 2710 | 2600 | 120 | 180 |
| 4 | BT—Acrylate | 250 | 270 | 2300 | 2034 | 83 | 139 |
| | | 275 | 273 | 2500 | 2270 | 93 | 195 |
| 5 | BT—Acrylate | 250 | 278 | 2020 | 2130 | 97 | 117 |
| | | 275 | 271 | 1900 | 1960 | 91 | 125 |

1.-63. (canceled)

64. An ink formulation for additive manufacturing, the formulation comprising at least one imide-extended bismaleimides (IE-BMI), at least one cyanate ester and optionally at least one additive, wherein the formulation is optionally free of a carrier.

65. The formulation according to claim 64, further comprising at least one extended bismaleimides (E-BMI).

66. The formulation according to claim 64, further comprising an inorganic precursor or a sol gel precursor soluble in the formulation.

67. The formulation according to claim 66, wherein the sol gel precursor is a di-, tri- or a tetra-alkoxysilane.

68. The formulation according to claim 67, wherein the sol gel precursor is selected from tetraethoxysilane (TEOS), 3-isocyanatopropyl trimethoxysilane; bisaminosilane; acryloxymethyltrimethoxysilane; methyltriethoxysilane; dimethyldimethoxysilane; phenyltrimethoxysilane; acryloxypropyltrimethoxysilane (APTMS); (3-glycidoxypropyl) trimethylsilane; silanediols; silanetriols; trisilanol phenyl (POSS); aluminum lactate; aluminum alokoxides; aluminum isopropoxide; aluminum chloride; tris (ethyl acetoacetate) aluminum; zirconium alkoxide; zirconium propoxide; zirconium nitrate; titanium alkoxide; titanium isopropoxide, titanium n-butoxide; titanium ethoxide; and niobium ethoxide.

69. The formulation according to claim 64, wherein the IE-BMI is of the general structure (I): 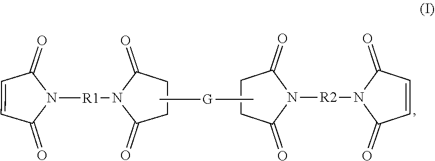
wherein each of R1 and R2, independently, is selected from carbon-based groups having between 1 and 50 carbon atoms;
G is a carbon-based group having between 1 and 50 carbon atoms; and wherein
each of the cyclic imide is optionally a fused ring or a substituted ring system.

70. The formulation according to claim 64, wherein each of the cyclic imide groups part of the IE-BMI is selected amongst fused cyclic imides, aryl-substituted and aryl-fused cyclic imides.

71. The formulation according claim 64, wherein the IE-BMI is a compound of formula (II) 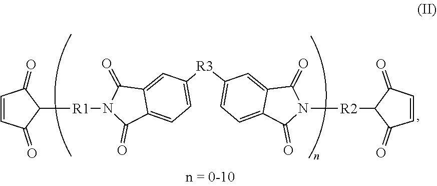
wherein each of R1 and R2, independently, is selected from carbon-based groups having between 1 and 50 carbon atoms, and wherein R3 is selected from aliphatic groups, aromatic groups, heteroaromatic groups, carbocyclic groups, saturated groups, and unsaturated groups, and wherein n is an integer between 0 and 10.

72. The formulation according to claim 71, wherein each of R1, R2 and R3, independently of the other, is a C36H70 alkylene group comprising all methylene groups.

73. The formulation according to claim 64, wherein the IE-BMI is selected from structures (III), (IV) and (V): 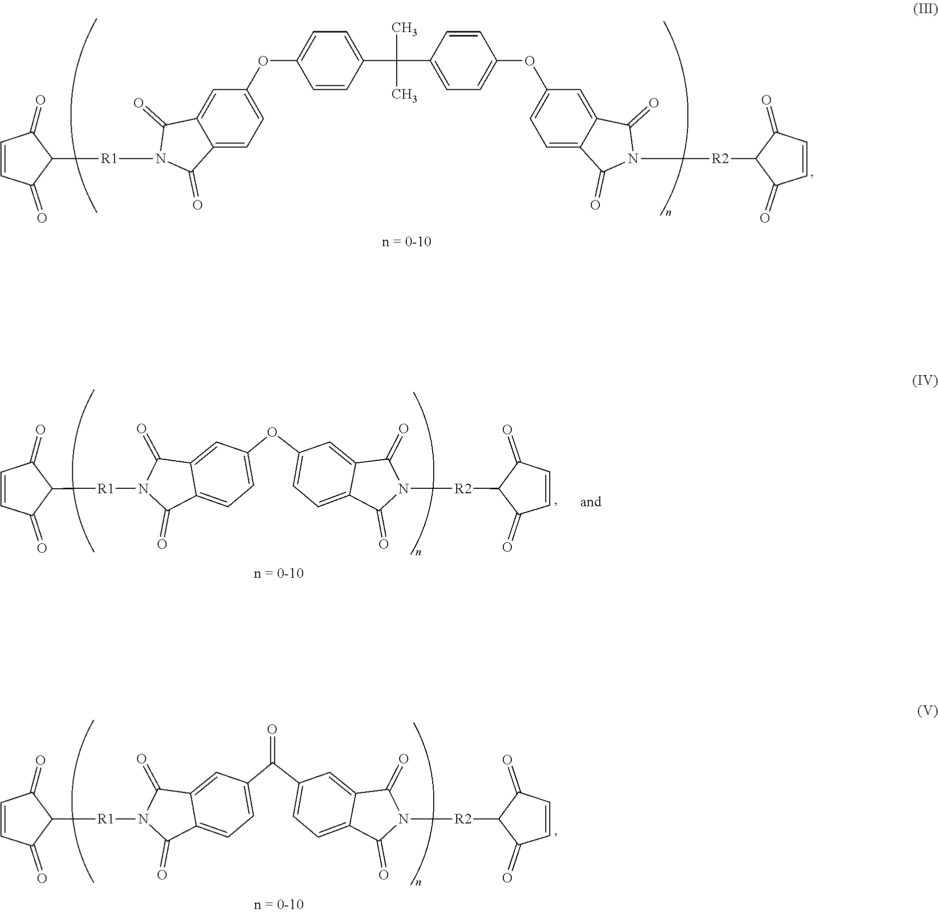
wherein in each of the structures (III) to (V), each of R1 and R2, independently of the other, is an aromatic or a heteroaromatic group having between 6 and 10 carbon atoms, and in case of a heteroaromatic group, one or more heteroatoms selected from N, O and S, and wherein each n is between 1 and 10.

74. The formulation according to claim 64, wherein the E-BMI is of a structure:

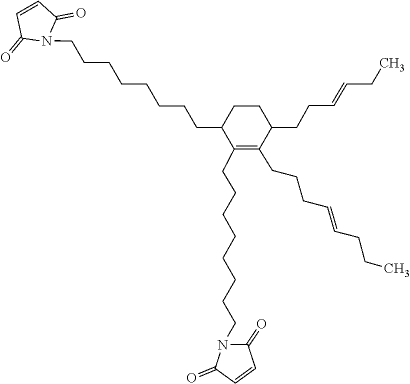 [SMILES: CC/C=C/CCC1CCC(CCCCCCCCN2C(=O)C=CC2=O)C(CCCCCCCCN2C(=O)C=CC2=O)=C1CCC/C=C/CCC]

75. The formulation according to claim 64, wherein the IE-BMI is selected from:

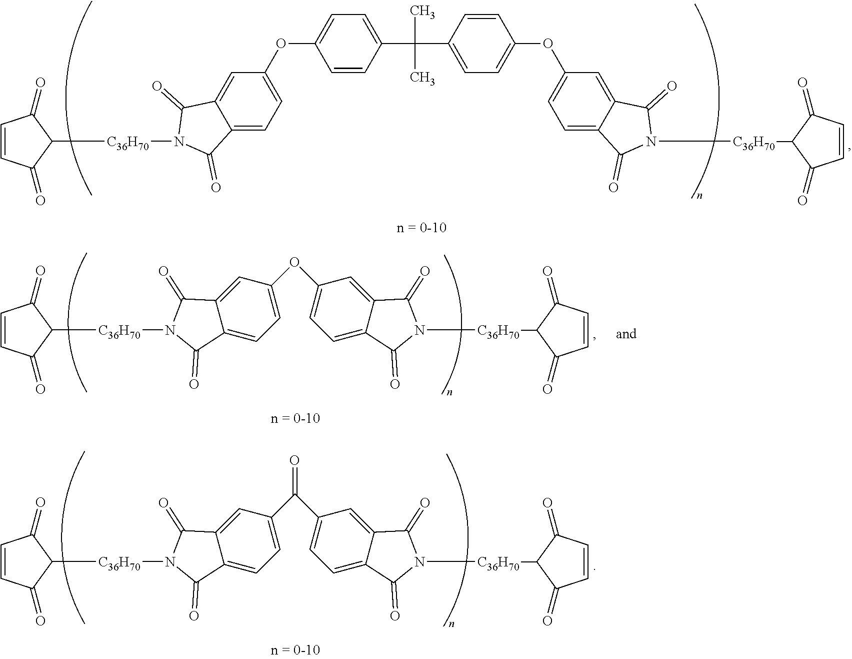

76. An ink formulation for additive manufacturing, the formulation comprising at least one imide-extended-bismaleimides (IE-BMI) and/or at least one extended-bismaleimide (E-BMI), at least one cyanate ester and at least one additive, wherein the IE-BMI is of the structure (I) 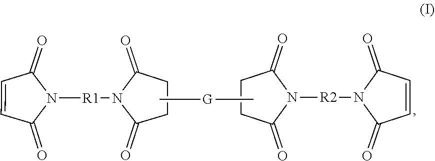
wherein each of R1 and R2,
independently, is selected from carbon-based groups having between 1 and 50 carbon atoms;
G is a carbon-based group having between 1 and 50 carbon atoms; and wherein each of the cyclic imide is optionally a fused ring or a substituted ring system.

77. The formulation according to claim 64, wherein the cyanate ester is of structure 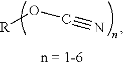
wherein R is selected from alkyl, cycloalkyl, aryl, heteroaryl, heteroalicyclic and a saturated or unsaturated hydrocarbon, optionally interrupted and/or substituted by one or more heteroatoms selected from Si, P, S, O and N, and wherein n is an integer between 1 and 6.

78. The formulation according to claim 64, wherein the cyanate ester is selected from 1,3-, or 1,4-dicyanatobenzene; I,3,5-tricyanatobenzene; 1,3-, 1,4-, 1,6-, 1,8-, 2,6- or 2,7-dicyanatonaphthalene; I,3,6-tricyanatoaphthalene; 2,2′ or 4,4′-dicyanatobiphenyl; bis(4-cyanathophenyl)methane; 2,2-bis(4-cyanatophenyl)propane; 2,2-bis(3,5-dichloro-4-cyanatophenyl)propane; 2,2-bis(3-dibromo-4-dicyanatophenyl)propane; bis(4-cyanatophenyl)ether; bis(4-cyanatophenyl) thioether; bis(4-cyanatophenyl)sulfone; tris(4-cyanatophenyl)phosphite; tris(4-cyanatophenyl)phosphate; bis(3-chloro-4-cyanatophenyl)methane: 4-cyanatobiphenyl; 4-cumyl cyanato benzene; 2-tert-butyl-I,4-dicyanatobenzene; 2,4-dimethyl-1,3-dicyanatobenzene; 2,5-di-tert-butyl-I,4-dicyanatobenzene; tetramethyl-1,4-dicyanatobenzene; 4-chloro-1,3-dicyanatobenzene; 3,3′,5,5′-tetramethyl-4,4′dicyanatodiphenyl; bis(3-chloro-4-cyanatophenyl)methane; I,I,I-tris(4-cyanatophenyl)ethane; I,I-bis(4-cyanatophenyl)ethane; 2,2-bis(3,5-dichloro-4-cyanatophenyl)propane; 2,2-bis(3,5-dibromo-4-cyanatophenyl)propane; bis(p-cyanophenoxyphenoxy) benzene; and any mixture thereof.

79. The formulation according to claim 64, further comprising a bismaleimide triazine (BT) resin or further comprising an epoxy resin.

80. The formulation according to claim 64, for use in digital light processing (DLP) or stereolithography (SLA).

81. A process for manufacturing an object, the process comprises printing a formulation according to claim 64, wherein the printing is carried out under conditions of digital light processing (DLP) or stereolithography (SLA).

82. An object formed of a formulation according to claim 64, wherein the object is a polymeric object, structure or pattern, implemented for use in aerospace aviation, automobile industry, electronic packaging, microelectronic insulation, corrosion resistance, films, medical device, and medical implants.
